(19) United States
(12) Patent Application Publication
(10) Pub. No.: US 2009/0155606 A1
(43) Pub. Date: Jun. 18, 2009

(54) METHODS OF DEPOSITING A SILICON NITRIDE FILM

(75) Inventors: Tae Ho Yoon, Anseong-si (KR); Hyung Sang Park, Seoul-si (KR); Hak Yong Kwon, Suwon-si (KR); Young Jae Kim, Cheonan-si (KR)

Correspondence Address: KNOBBE MARTENS OLSON & BEAR LLP, 2040 MAIN STREET, FOURTEENTH FLOOR, IRVINE, CA, 92614, US

(73) Assignee: ASM GENITECH KOREA LTD., Cheonan-si (KR)

(21) Appl. No.: 12/325,862

(22) Filed: Dec. 1, 2008

(30) Foreign Application Priority Data
Dec. 13, 2007 (KR) 10-2007-0130386

(51) Int. Cl. B32B 9/00

(52) U.S. Cl. 428/446; 427/578

(57) ABSTRACT

Cyclical methods of depositing a silicon nitride film on a substrate are provided. In one embodiment, a method includes supplying a chlorosilane to a reactor in which a substrate is processed; supplying a purge gas to the reactor; and providing ammonia plasma to the reactor. The method allows a silicon nitride film to be formed at a low process temperature and a high deposition rate. The resulting silicon nitride film has a relatively few impurities and a relatively high quality. In addition, a silicon nitride film having good step coverage over features having high aspect ratios and a thin and uniform thickness can be formed.

### CROSS-REFERENCE TO RELATED APPLICATIONS

This application claims priority to and the benefit of Korean Patent Application No. 10-2007-0130386 filed in the Korean Intellectual Property Office on Dec. 13, 2007, the entire contents of which are incorporated herein by reference.

### BACKGROUND

1. Field

The present invention relates to a method of depositing a thin film. More particularly, the present invention relates to a method of depositing a silicon nitride film.

2. Description of the Related Art

Silicon nitride (Si₃N₄) films have excellent oxidation resistance and insulating characteristics. Thus, silicon nitride films have been used for various applications, for example, oxide/nitride/oxide (ONO) stacks, etch-stops, oxygen diffusion barriers, gate insulation layers, and so on.

In certain instances, a plasma enhanced chemical vapor deposition (PECVD) method may be used for depositing a silicon nitride film on a substrate. The PECVD method may include supplying a silicon source gas, e.g., silane, and a nitrogen source gas, e.g., nitrogen (N₂) gas or ammonia (NH₃) gas, simultaneously to a reactor in which a substrate is processed while applying radio frequency (RF) power to the reactor.

In other instances, a low pressure chemical vapor deposition (LPCVD) method may be used for depositing a silicon nitride film. The LPCVD method may include supplying a silicon source gas, e.g., dichlorosilane (DCS), bis-tert-butylaminosilane (BTBAS), or hexachlorodisilane (HCDS), and a nitrogen source gas, e.g., ammonia (NH₃) gas, simultaneously to a reactor in which a substrate is processed. The LPCVD can be performed at a relatively low pressure of about 0.1 torr to about 5 torr and at a relatively high temperature of about 800° C. to about 900° C.

While the plasma enhanced chemical vapor deposition (PECVD) method allows for deposition at a relatively low temperature with a relatively high deposition rate, a silicon nitride film deposited by PECVD typically has defects, such as a high hydrogen concentration, low thermal stability, and low step coverage.

In performing low pressure chemical vapor deposition (LPCVD) in a deposition apparatus, by-products, such as ammonium chloride (NH₄Cl₄), may be formed by a reaction between a silicon source gas and ammonia gas. Such by-products may be accumulated in an exhaust system of the deposition apparatus. In addition, the deposition rate is relatively very low. Furthermore, the deposition is performed at a relatively high temperature, and thus interface oxidation may occur. This may cause a leakage current when the silicon nitride film is used for an insulation layer. Electrical characteristics of the resulting silicon nitride film may be poor when the silicon nitride film is used for a wiring process.

Recently, as the density of semiconductor devices has increased, attempts have been made to develop semiconductor devices having a relatively high aspect ratio. Accordingly, there has been a need for a method for depositing a silicon nitride film having good step coverage over features having a high aspect ratio, and a thin and uniform thickness. However, it is difficult to form a thin film having good step coverage on substantially the entire surface of a structure having a high aspect ratio with CVD.

The above information disclosed in this Background section is only for enhancement of understanding of the background of the invention and therefore it may contain information that does not form the prior art that is already known in this country to a person of ordinary skill in the art.

### SUMMARY

In one embodiment, a method of depositing a silicon nitride film includes: loading a substrate into a reactor; and conducting one or more deposition cycles. At least one of the cycles includes steps of: supplying a halo-silane to the reactor; supplying a purge gas to the reactor; and providing ammonia plasma to the reactor after supplying the silicon source gas and the purge gas without supplying the silicon source gas.

In another embodiment, a method of depositing a silicon nitride film includes: loading a substrate into a reactor; and conducting one or more atomic layer deposition (ALD) cycles. At least one of the cycles comprising steps of: supplying a halo-silane to the reactor; supplying a purge gas to the reactor after supplying the silicon source gas; supplying ammonia gas to the reactor after supplying the purge gas; and applying radio frequency (RF) power to the reactor to generate ammonia plasma after supplying the silicon source gas and the purge gas without supplying the silicon source gas.

In yet another embodiment, an apparatus includes: a substrate; a silicon nitride film formed over the substrate, wherein the silicon nitride film is formed by conducting one or more deposition cycles. At least one of the cycles includes steps of: supplying a chlorosilane gas to the reactor; supplying a purge gas to the reactor; and providing ammonia plasma to the reactor after supplying the silicon source gas and the purge gas without supplying the silicon source gas. The silicon nitride film contains chlorine atoms in an amount less than about 1.2 atomic %.

### BRIEF DESCRIPTION OF THE DRAWINGS

FIG. 1 is a flowchart illustrating a method of supplying gases for formation of a silicon nitride film according to one embodiment.

FIG. 2 shows contamination particles of a silicon nitride film deposited by a deposition method according to one embodiment.

FIG. 3 is a graph illustrating atomic emission spectroscopy (AES) analysis results of a silicon nitride film deposited by a deposition method according to one exemplary embodiment.

### DETAILED DESCRIPTION OF EMBODIMENTS

The invention will be described more fully hereinafter with reference to the accompanying drawings, in which exemplary embodiments are shown. As those skilled in the art would realize, the described embodiments may be modified in various different ways, all without departing from the spirit or scope of the invention.

In one embodiment, a method of depositing a silicon nitride film over a substrate includes subjecting the substrate to alternately repeated surface reactions of vapor-phase reactants in a reactor. In some embodiments, the method employs atomic layer deposition (ALD). The method may include one or more deposition cycles. At least one of the cycles may include steps of: supplying a silicon source gas; purging the reactor; supplying ammonia plasma as a nitrogen source gas; and optionally purging the reactor.

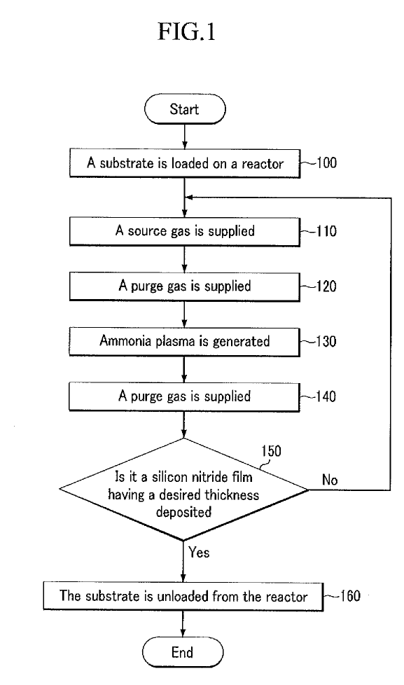

Referring to FIG. 1, a deposition method for formation of a silicon nitride film according to one embodiment will be described below. FIG. 1 is a flowchart illustrating a method of supplying gases for formation of a silicon nitride film according to the embodiment.

At step 100, a substrate on which a silicon nitride film is to be deposited is loaded into a reactor. The reactor may be any suitable reactor for plasma enhanced atomic layer deposition. In other embodiments, the reactor may be a chemical deposition reactor.

Subsequently, one or more deposition cycles may be performed on the substrate. At least one of the cycles may include the following steps. First, a silicon source gas is supplied to the reactor at step 110. In one embodiment, the silicon source gas may be a silicon-containing compound, such as a silane compound. The silane compound may include halo-silanes, such as chlorinated silanes, particularly per-chlorinated silanes, such as hexachlorodisilane (Si₂Cl₆; HCDS). Hexachlorodisilane is represented by Formula 1 below.

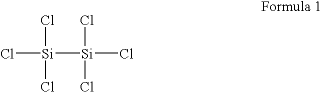

Other examples of silane compounds include, but are not limited to, dichlorosilane (H₂SiCl₂; DCS) and bis-tert-butylaminosilane (SiH₂(NH(C₄H₉)₂; BTBAS). For a single wafer PEALD reactor, such as a Stellar-3000 reactor commercially available from ASM Genitech Korea of Cheonan-si, Chungcheongnam-do, Republic of Korea, the silicon source gas may be supplied at a flow rate of about 100 sccm to about 1,000 sccm for a pulse duration of about 2 seconds to about 10 seconds.

Next, a purge gas is supplied at step 120. The purge gas may be any suitable inert gas, such as argon (Ar). The purge gas may be supplied at a flow rate of about 100 sccm to about 1,000 sccm for a duration of about 0.5 seconds to about 10 seconds. The purge gas serves to remove excess silicon source gas and any by-products from the reactor.

Subsequently, ammonia plasma is provided as a nitrogen source gas to the reactor at step 130. In one embodiment, ammonia is generated in-situ by supplying ammonia (NH₃) gas to the reactor while applying electric power (e.g., radio frequency (RF) power) to the reactor. The electric power may be from several watts to several kilowatts. In one embodiment, the electric power may be about 100 W to about 3000 W. The electric power may have a frequency of about 13.56 MHz or about 27.12 MHz. The ammonia gas may be supplied at a flow rate of about 50 sccm to about 2,000 sccm for a pulse duration of about 0.2 seconds to about 10 seconds.

In one embodiment, the ammonia gas may be continuously supplied to the reactor throughout at least one of the deposition cycles, and electric power may be applied only during the step 130. In another embodiment, the ammonia gas may be supplied to the reactor only during the step 130, that is, only while the electric power is on. For example, to ensure only plasma-activated ammonia is supplied to the substrate, plasma power is applied before flowing ammonia gas into the reactor, e.g., during the immediately previous purge step, and is kept on during the ammonia flow. In certain embodiments, remotely generated ammonia plasma may be supplied to the reactor.

At step 140, a purge gas is supplied to the reactor. The purge gas may be any suitable inert gas, such as argon (Ar). The purge gas may be supplied at a flow rate of about 100 sccm to about 1,000 sccm for a duration of about 0 second to about 10 seconds. The purge gas serves to remove excess ammonia plasma and any by-products from the reactor. In some embodiments, this purge step (step 140) may be omitted.

The deposition cycles may be performed at a temperature of about 100° C. to about 500° C. and a deposition pressure of about 0.1 torr to about 10 torr. In certain embodiments, the duration of each of the steps 110-140 may be about 0.2 seconds to about 10 seconds. A skilled artisan will, however, appreciate that the deposition temperature, the deposition pressure, and/or the durations of the steps can vary widely, depending on the volume and structure of a reactor.

The deposition cycle including the steps 110-140 may be repeated until a silicon nitride film having a desired thickness is formed on the substrate (step 150). In one embodiment, the steps 110-140 may be repeated about 100 times to about 500 times. When a silicon nitride film having a desired thickness has been formed, the substrate is unloaded from the reactor at step 160.

### EXAMPLES A-1 to A-3

A silicon nitride film was formed using the method described above in connection with FIG. 1. Other silicon nitride films were formed using methods employing different nitrogen source gases for comparison of deposition rates and film properties.

In Examples A-1 to A-3, methods included the same steps as those of FIG. 1 except that the nitrogen source gases were different from one another. The methods included supplying hexachlorodisilane as a silicon source gas. In Example A-1, nitrogen plasma was supplied as a nitrogen source gas. In Example A-2, non-plasma ammonia gas was supplied as a nitrogen source gas. In Example A-3, ammonia plasma was provided as a nitrogen source gas.

In Examples A-1 to A-3, the methods were performed at a process temperature of about 300° C. and a process pressure of about 3 torr. In Examples A-1 to A-3, the nitrogen source gases were supplied at a flow rate of about 400 sccm. In Examples A-1 and A-3, an electric power to generate plasma was about 600 W. The deposition rates of Examples A-1 to A-3 are shown in Table 1.

TABLE 1

| | | | Deposition Rate |
|---|---|---|---|
| | Silicon Source | Nitrogen Source | (Å/cycle) |
| Example A-1 | hexachlorodisilane | nitrogen plasma | 0 |
| Example A-2 | hexachlorodisilane | ammonia | 0.09 |
| Example A-3 | hexachlorodisilane | ammonia plasma | 0.54 |

No silicon nitride layer was deposited in Example A-1. It was found that the deposition rate of Example A-3 was higher than that of Example A-2. Thus, it was noted that ammonia plasma has a higher reactivity with the silicon source gas than non-plasma ammonia gas. As shown above, the deposition rate was increased when a silicon nitride film was deposited using ammonia plasma as a nitrogen source gas, compared to using non-plasma ammonia.

### EXAMPLES B-1 to B-4

In Examples B-1 to B-4, silicon nitride films were formed using the method described above in connection with FIG. 1 with varying deposition conditions. In Examples B-1 to B-4, methods included the same steps as those of FIG. 1. The methods used hexachlorodisilane as a silicon source and ammonia plasma as a nitrogen source.

In Examples B-1 and B-2, deposition temperatures were different from each other, but all the other conditions were the same as each other. In Example B-1, the deposition temperature was 200° C. In Example B-2, the deposition temperature was 300° C. The resulting deposition rates are shown in Table 2.

In Example B-3, an applied electric power was different from that of Example 2, but all the other conditions were the same as those of Example B-2. In Example B-2, the electric power was 600 W. In Example B-3, the electric power was 1000 W. The resulting deposition rates are shown in Table 2.

In Example B-4, an ammonia flow rate was different from that of Example 2, but all the other conditions were the same as those of Example B-2. In Example B-2, the ammonia gas flow rate was 400 sccm. In Example B-4, the ammonia gas flow rate was 100 sccm. The resulting deposition rates are shown in Table 2.

TABLE 2

| | Deposition | Electric | Ammonia | Deposition | Deposition |
|---|---|---|---|---|---|
| | temperature | power | flow rate | pressure | rate |
| | (° C.) | (W) | (sccm) | (torr) | (Å/cycle) |
| Example B-1 | 200 | 600 | 400 | 3 | 0.48 |
| Example B-2 | 300 | 600 | 400 | 3 | 0.56 |
| Example B-3 | 300 | 1000 | 400 | 3 | 0.65 |
| Example B-4 | 300 | 600 | 100 | 3 | 0.51 |

Referring to Table 2, all the deposition rates of Examples B-1 to B-4 are relatively higher than that of Example A-2 where non-plasma ammonia gas was used as a nitrogen source gas. Table 2 also shows that the deposition rate is higher at a deposition temperature of 300° C. than at a deposition temperature of 200° C. It was also found that the deposition rate at an electric power of 1000 W is higher than that at an electric power of 600 W. In addition, it was found that the deposition rate at an ammonia flow rate of 400 sccm is higher than that at an ammonia flow rate of 100 sccm.

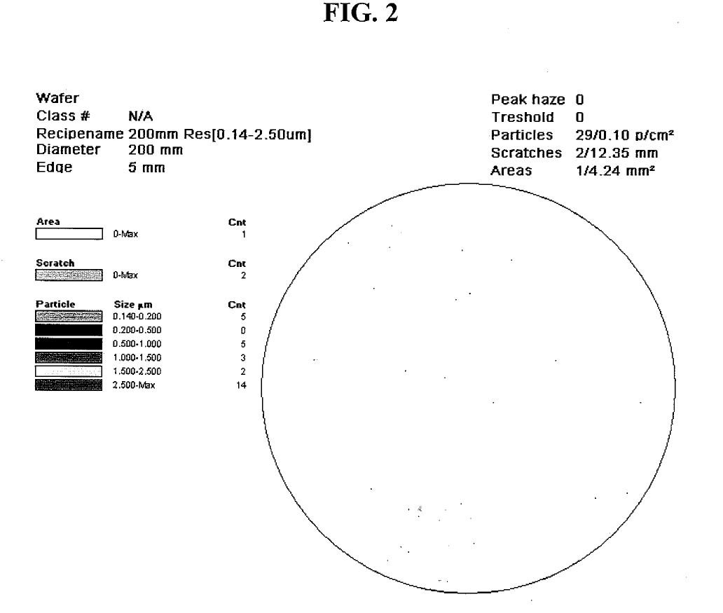

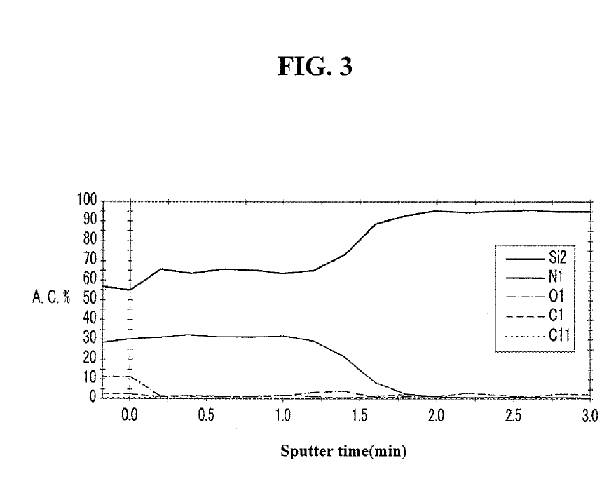

Referring now to FIGS. 2 and 3, film properties of silicon nitride films deposited by the methods of the embodiments described above will be described below.

### EXAMPLE C

In Example C, residual particle distribution after completion of formation of a silicon nitride film by the deposition method of FIG. 1 was measured. A silicon nitride film was deposited by the deposition method of Example A-3. In Example C, the method was performed at a process temperature of about 300° C. and a process pressure of about 3 torr. The ammonia gas was supplied at a flow rate of about 400 sccm. The electric power to generate ammonia plasma was about 600 W.

After the completion of the method, a number of residual particles was counted by a particle counter. The particle counter detected residual particles having a size of about 0.14 microns or greater, and scratches on the surface of the silicon nitride film. The result of the residual particles after the completion of the method is shown in FIG. 2 As shown in FIG. 2, the number of particles having a size of 0.14 microns and greater after process was 29/0.10 p/cm², which is relatively very small.

### EXAMPLE D

Referring to FIG. 3, an atomic composition of a silicon nitride layer deposited by the methods of the embodiments described above will be described below. In Example D, a silicon nitride film was deposited by the same method as that of Example C.

Atomic emission spectroscopy (AES) analysis was performed on the silicon nitride film. FIG. 3 is a depth profile graph representing the result of the AES analysis. The silicon nitride film deposited by the deposition method primarily contained silicon (Si) atoms and nitrogen (N) atoms with a few percent of certain impurities, such as carbon (C) atoms, chlorine (Cl) atoms, and oxygen (O) atoms. In Example D, the resulting silicon nitride film contains total impurities in an amount less than about 2 atomic % or optionally less than about 1.6 atomic %. The silicon nitride film may contain chlorine atoms in an amount less than about 1.2 atomic %. The silicon nitride film was found to have fewer impurities and higher quality than a silicon nitride film deposited by conventional chemical vapor deposition (CVD) methods. Thus, the resulting silicon nitride film has an atomic ratio close to that of stoichiometric silicon nitride (Si₃N₄). In addition, such silicon nitride film may not have substrate interface oxidation problems.

According to the embodiments, a silicon nitride film may be formed at a relatively low process temperature and at a relatively high deposition rate. The resulting silicon nitride film has fewer impurities and higher quality. In addition, because an atomic layer deposition (ALD) method is used in the embodiments, the resulting silicon nitride film can have better step coverage over features having a high aspect ratio, and a thin and uniform thickness, compared to a film formed by chemical vapor deposition (CVD).

Although various preferred embodiments and the best mode have been described in detail above, those skilled in the art will readily appreciate that many modifications of the exemplary embodiment are possible without materially departing from the novel teachings and advantages of this invention.

We claim:

1. A method of depositing a silicon nitride film, the method comprising:
loading a substrate into a reactor; and
conducting one or more deposition cycles, at least one of the cycles comprising steps of:
supplying a halo-silane to the reactor;
supplying a purge gas to the reactor; and
providing ammonia plasma to the reactor after supplying the silicon source gas and the purge gas without supplying the silicon source gas.

2. The method of claim 1, wherein the at least one of the cycles further comprises supplying a purge gas after providing the ammonia plasma.

3. The method of claim 1, wherein the halo-silane comprises a chlorosilane.

4. The method of claim 3, wherein the chlorosilane comprises hexachlorodisilane (HCDS).

5. The method of claim 1, wherein conducting the deposition cycles comprises conducting the deposition cycles at a temperature of about 100° C. to about 500° C.

6. The method of claim 1, wherein conducting the deposition cycles comprises conducting the deposition cycles at a reactor pressure of about 0.1 torr to about 10 torr.

7. The method of claim 1, wherein providing ammonia plasma comprises generating in-situ ammonia plasma in the reactor.

8. The method of claim 7, wherein providing ammonia plasma comprises supplying ammonia gas to the reactor at a flow rate between about 50 sccm and about 2000 sccm.

9. The method of claim 7, wherein providing ammonia plasma comprises applying an electric power of about 100 W to about 3000 W to the reactor.

10. The method of claim 7, wherein providing ammonia plasma comprises:
supplying ammonia gas to the reactor substantially continuously throughout the at least one of the cycles;
applying electric power to the reactor after supplying the silicon source gas and the purge gas without supplying the silicon source gas.

11. The method of claim 7, wherein providing ammonia plasma comprises:
applying electric power to the reactor after supplying the silicon source gas and the purge gas without supplying the silicon source gas; and
supplying ammonia gas to the reactor after supplying the silicon source gas while applying electric power to the reactor.

12. The method of claim 1, wherein providing ammonia plasma comprises supplying remotely generated ammonia plasma to the reactor.

13. The method of claim 1, wherein conducting the one or more deposition cycles comprises repeating the at least one of the cycles until a film having a desired thickness is formed over the substrate.

14. A method of depositing a silicon nitride film, the method comprising:
loading a substrate into a reactor; and
conducting one or more atomic layer deposition (ALD) cycles, at least one of the cycles comprising steps of:
supplying a halo-silane to the reactor;
supplying a purge gas to the reactor after supplying the silicon source gas;
supplying ammonia gas to the reactor after supplying the purge gas; and
applying radio frequency (RF) power to the reactor to generate ammonia plasma after supplying the silicon source gas and the purge gas without supplying the silicon source gas.

15. The method of claim 14, wherein the at least one of the cycles further comprises supplying a purge gas after applying the electric power.

16. The method of claim 14, wherein the halo-silane comprises a chlorosilane.

17. The method of claim 14, wherein the chlorosilane is selected from the group consisting of dichlorosilane (DCS) and hexachlorodisilane (HCDS).

18. The method of claim 14, wherein supplying the ammonia gas comprises supplying the ammonia gas to the reactor only during applying the RF power to the reactor.

19. An apparatus, comprising:
a substrate;
a silicon nitride film formed over the substrate, wherein the silicon nitride film is formed by conducting one or more deposition cycles, at least one of the cycles comprising steps of:
supplying a chlorosilane gas to the reactor;
supplying a purge gas to the reactor; and
providing ammonia plasma to the reactor after supplying the silicon source gas and the purge gas without supplying the silicon source gas,
wherein the silicon nitride film contains chlorine atoms in an amount less than about 1.2 atomic %.
